(19) United States
(12) Patent Application Publication
(10) Pub. No.: US 2026/0290939 A1
(43) Pub. Date: Sep. 24, 2026

(54) BATTERY MODULE WITH INTEGRATED COLD PLATE

(71) Applicant: GM GLOBAL TECHNOLOGY OPERATIONS LLC, DETROIT, MI (US)

(72) Inventor: Andrzej Leszczynski, Chesterfield, MI (US)

(21) Appl. No.: 19/084,091

(22) Filed: Mar. 19, 2025

(51) Int. Cl. H01M 10/6554; H01M 10/613; H01M 10/647; H01M 10/6556; H01M 50/209; H01M 50/224; H01M 50/249; H01M 50/26

(52) U.S. Cl. CPC H01M 10/6554; H01M 10/613; H01M 10/647; H01M 10/6556; H01M 50/209; H01M 50/224; H01M 50/249; H01M 50/26; H01M 2220/20

(57) ABSTRACT

A rechargeable energy storage system (RESS) of a vehicle includes a plurality of battery cells, and a battery enclosure configured to contain the plurality of battery cells. The battery enclosure includes an enclosure shell formed from a plurality of assembled metal components and a cold plate installed to at least one side of the enclosure shell. The cold plate is in thermal communication with the plurality of battery cells to cool the plurality of battery cells disposed in the enclosure shell.

### BACKGROUND

The subject disclosure relates to vehicles, and in particular to rechargeable energy storage systems (RESS's), or battery systems of vehicles.

RESS's are utilized to provide electrical power for propulsion and other functions of vehicle systems to which the RESS is connected. RESS's typically include a plurality of battery cells located in a battery enclosure. The battery cells and the battery enclosure define the RESS. Cooling systems are typically utilized to maintain a selected temperature of the battery cells inside the battery enclosure. Additionally, the battery enclosure is typically sealed to maintain a selected pressure of the battery cells in the battery enclosure. The typical cooling systems are often complex and limit options for order of assembly of the RESS structure.

### SUMMARY

In one exemplary embodiment, a rechargeable energy storage system (RESS) of a vehicle includes a plurality of battery cells, and a battery enclosure configured to contain the plurality of battery cells. The battery enclosure includes an enclosure shell formed from a plurality of assembled metal components and a cold plate installed to at least one side of the enclosure shell. The cold plate is in thermal communication with the plurality of battery cells to cool the plurality of battery cells disposed in the enclosure shell.

In addition to one or more of the features described herein, the enclosure shell includes a shell base, a shell cap spaced apart from the shell base, and a plurality of shell sidewalls extending between the shell base and the shell cap. The cold plate is positioned at the shell base.

In addition to one or more of the features described herein, the shell base includes one or more base openings to improve thermal contact between the cold plate and the plurality of battery cells.

In addition to one or more of the features described herein, one or more dividers extend between two shell sidewalls of the enclosure shell.

In addition to one or more of the features described herein, the enclosure shell is formed via one or more of spot welding, laser welding, MIG welding, riveting, or self-pierce riveting.

In addition to one or more of the features described herein, the cold plate includes a fluid inlet, a fluid outlet, and one or more fluid pathways extending through the cold plate between the fluid inlet and the fluid outlet.

In addition to one or more of the features described herein, the enclosure shell includes one or more sidewall recesses. At least one of the fluid inlet and the fluid outlet is positioned at a sidewall recess of the one or more sidewall recesses.

In addition to one or more of the features described herein, the plurality of battery cells are a plurality of prismatic battery cells.

In another exemplary embodiment, a vehicle includes a vehicle body, a powertrain positioned at the vehicle body to drive movement of the vehicle, and a rechargeable energy storage system (RESS) operably connected to the powertrain. The RESS includes a plurality of battery cells, and a battery enclosure configured to contain the plurality of battery cells. The battery enclosure includes an enclosure shell formed from a plurality of assembled metal components, and a cold plate installed to at least one side of the enclosure shell. The cold plate is positioned in thermal communication with the plurality of battery cells to cool the plurality of battery cells disposed in the enclosure shell.

In addition to one or more of the features described herein, the enclosure shell includes a shell base, a shell cap spaced apart from the shell base, and a plurality of shell sidewalls extending between the shell base and the shell cap. The cold plate is positioned at the shell base.

In addition to one or more of the features described herein, the shell base includes one or more base openings to improve thermal contact between the cold plate and the plurality of battery cells.

In addition to one or more of the features described herein, one or more dividers extend between two shell sidewalls of the enclosure shell.

In addition to one or more of the features described herein, the enclosure shell is formed via one or more of spot welding, laser welding, MIG welding, riveting, or self-pierce riveting.

In addition to one or more of the features described herein, the cold plate includes a fluid inlet, a fluid outlet, and one or more fluid pathways extending through the cold plate between the fluid inlet and the fluid outlet.

In addition to one or more of the features described herein, the enclosure shell includes one or more sidewall recesses. At least one of the fluid inlet and the fluid outlet are positioned at a sidewall recess of the one or more sidewall recesses.

In addition to one or more of the features described herein, the plurality of battery cells are a plurality of prismatic battery cells.

In yet another exemplary embodiment, a method of assembly of a rechargeable energy storage system (RESS) includes forming a plurality of components of an enclosure shell, arranging and assembling the enclosure shell from the plurality of components, and securing a cold plate to the enclosure shell. A plurality of battery cells are installed into the enclosure shell after securing of the cold plate to the enclosure shell. The cold plate is positioned in thermal contact with the plurality of battery cells.

In addition to one or more of the features described herein, the plurality of components are formed by one of stamping or press-braking.

In addition to one or more of the features described herein, the enclosure shell is assembled into a rectangular cuboid.

In addition to one or more of the features described herein, the enclosure shell is assembled via one or more of spot welding, laser welding, MIG welding, riveting, or self-pierce riveting.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of an exemplary embodiment of a vehicle;

FIG. 2 is a cross-sectional view of an embodiment of a rechargeable energy storage system (RESS) of a vehicle;

FIG. 3 is a cross-sectional view of an embodiment of an RESS enclosure; and

FIG. 4 is a schematic illustration of an embodiment of a method of assembly of a RESS.

### DETAILED DESCRIPTION

The following description is merely exemplary in nature and is not intended to limit the present disclosure, its application or uses. It should be understood that throughout the drawings, corresponding reference numerals indicate like or corresponding parts and features.

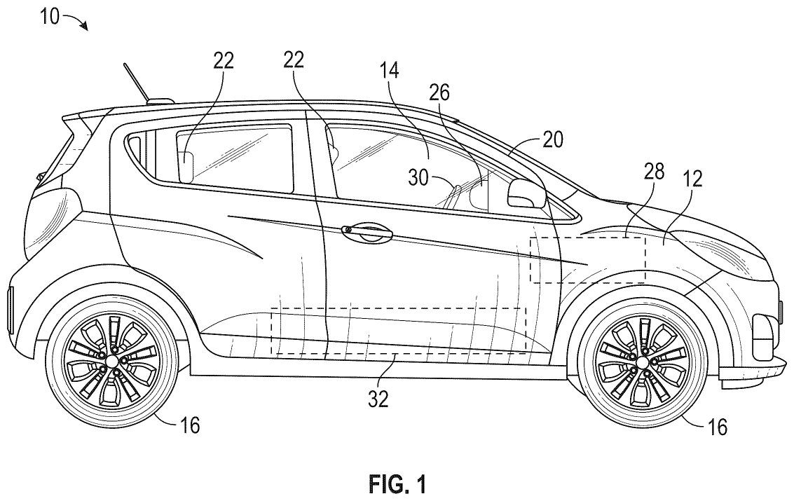

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, an occupant compartment 14 having seats 22 positioned behind a dashboard 26. A steering control 30 is arranged between seats 22 and dashboard 26. Steering control 30 is operated to control orientation of the steerable wheel(s) 16. A powertrain 28 is operably connected to the plurality of wheels 16, and one or more components of the powertrain 28. A rechargeable energy storage system (RESS) 32 is operably connected to the powertrain 28 and, in some embodiments, other vehicle 10 components or systems. The RESS 32 provides electrical power to the powertrain 28 for propulsion of the vehicle 10.

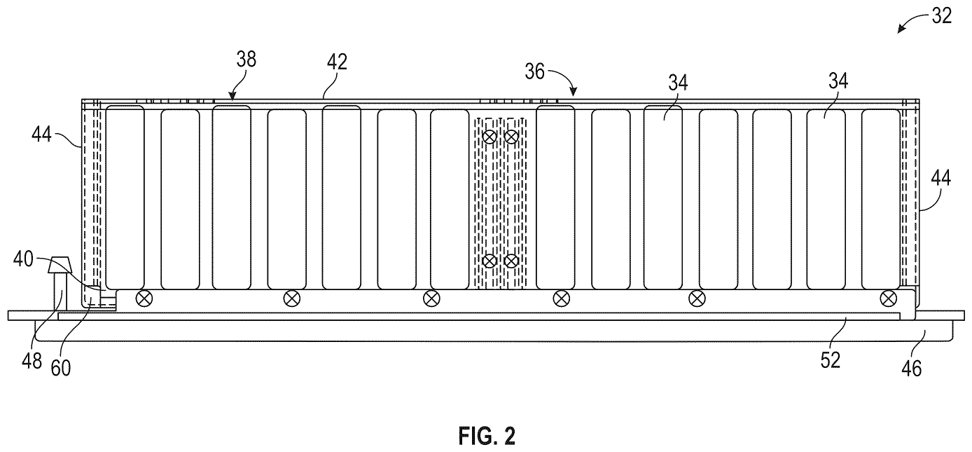

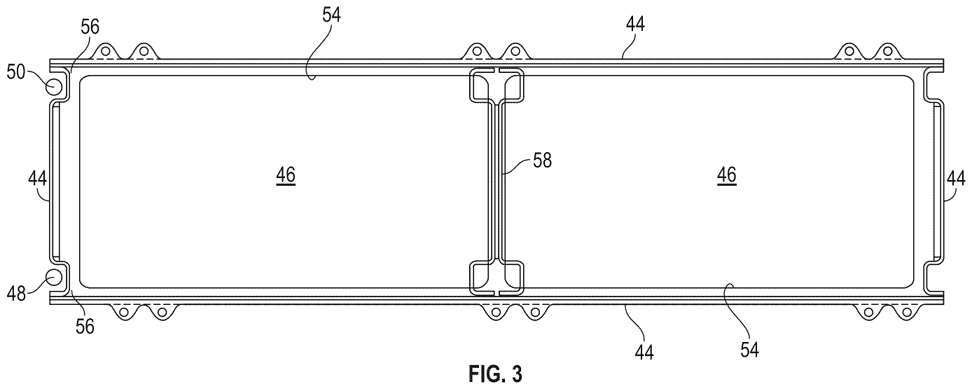

Referring now to FIG. 2, the RESS 32 includes a plurality of battery cells 34 positioned inside of a battery enclosure 36. In some embodiments the battery cells 34 are prismatic battery cells 34, but this is merely exemplary. One skilled in the art will readily appreciate that other types of battery cells 34 may be utilized in the RESS 32. The battery enclosure 36 includes an enclosure shell 38 formed from a metal material, such as steel or aluminum, and includes a shell base 40, a shell cap 42, and a plurality of shell sidewalls 44 (best shown in FIG. 3) extending between the shell base 40 and the shell cap 42. While in some embodiments, the shell base 40, the shell cap 42 and the shell sidewalls 44 are formed from the same material, in other embodiments the materials and/or material properties such as material thickness, may be varied among the components of the enclosure shell 38.

In some embodiments, the shell base 40 and the shell cap 42 are substantially rectangular, so that the resulting enclosure shell 38 is substantially a rectangular cuboid. One skilled in the art will readily appreciate that the enclosure shell 38 may be other 3-dimensional shapes. The enclosure shell 38 components may be assembled using one or more of a plurality of methods including one or more of spot welding, laser welding, MIG welding, riveting, or self-pierce riveting.

The battery enclosure 36 further includes a cold plate 46 secured to the enclosure shell 38 at, for example, the shell base 40. The cold plate 46 is secured to the enclosure shell 38 by one or more of a plurality of methods including one or more of spot welding, laser welding, MIG welding, riveting, or self-pierce riveting. The cold plate 46 includes a fluid inlet 48 and a fluid outlet 50 (best shown in FIG. 3), and one or more fluid flow channels 52 extend through the cold plate 46 between the fluid inlet 48 and the fluid outlet 50. A cooling fluid, such as a refrigerant, is circulated through the fluid flow channels 52 to cool the plurality of battery cells 34 disposed inside of the enclosure shell 38.

Referring now to FIG. 3, to improve the thermal contact between the cold plate 46 and the battery cells 34, the shell base 40 includes one or more base openings 54 formed therein. The one or more base openings 54 allow for direct contact between at least some of the battery cells 34 and the cold plate 46 to improve cooling performance of the cold plate 46. As also shown in FIG. 3, the enclosure shell 38 may include one or more shell recesses 56 in, for example, one or more of the shell sidewalls 44 to accommodate the fluid inlet 48 and/or the fluid outlet 50. Further, the enclosure shell 38 may have one or more dividers 58 disposed therein and secured to the shell sidewalls 44. The one or more dividers 58 are configured and positioned to support the shell sidewalls 44 and the shell cap 42 an improve the strength of the enclosure shell 38. In addition to improving contact between the cold plate 46 and the battery cells 34, the base openings 54 allow for the enclosure shell 38 to be assembled as a unit prior to installation of the battery cells 34 into the enclosure shell 38 via the base openings 54. In some embodiments, a thermal interface material layer 60 (shown in FIG. 2) is disposed between the battery cells 34 and the cold plate 46 to further improve thermal performance of the cold plate 46.

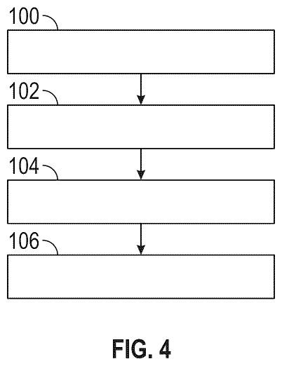

An exemplary method of assembling an RESS 32 is illustrated in FIG. 4. In step 100, the components of the enclosure shell 38 are formed by, for example, stamping or press-braking. In step 102, the components of the enclosure shell 38 are arranged and secured to define the enclosure shell 38. The cold plate 46 is installed to the enclosure shell 38 at step 104 and is secured thereto by a selected method. After the cold plate 46 is installed to the enclosure shell 38, the plurality of battery cells 34 are installed into the enclosure shell 38 at step 106.

The RESS 32 configurations disclosed herein allow for the preassembly of the enclosure shell 38, thus streamlining the overall manufacturing process of the RESS 32, leading to a reduction in scrap and potential environmental waste. Additionally, various fastening methods are supported, including spot welding, laser welding, MIG welding, riveting, and self-pierce riveting, offering versatility in assembly. The disclosed configurations further support flexible construction techniques such as stamping or press-braking, accommodating various production requirements. Further, the configurations design offers a low-cost manufacturing method, reducing production expenses, and allows for leak testing of the cold plate 46 prior to completion of the RESS 32 assembly. Additionally, the structure may be constructed using similar or dissimilar materials, enhancing flexibility in design and manufacturing. The modularity of the RESS 32 configuration allows for service at the module lever, enhancing maintainability and extending the lifespan of the battery system.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A rechargeable energy storage system (RESS) of a vehicle, comprising:
a plurality of battery cells; and
a battery enclosure configured to contain the plurality of battery cells, the battery enclosure including:
an enclosure shell formed from a plurality of assembled metal components; and
a cold plate installed to at least one side of the enclosure shell, the cold plate in thermal communication with the plurality of battery cells to cool the plurality of battery cells disposed in the enclosure shell.

2. The RESS of claim 1, wherein the enclosure shell includes:
a shell base;
a shell cap spaced apart from the shell base; and
a plurality of shell sidewalls extending between the shell base and the shell cap;
wherein the cold plate is disposed at the shell base.

3. The RESS of claim 2, wherein the shell base includes one or more base openings to improve thermal contact between the cold plate and the plurality of battery cells.

4. The RESS of claim 2, further comprising one or more dividers extending between two shell sidewalls of the enclosure shell.

5. The RESS of claim 2, wherein the enclosure shell is formed via one or more of spot welding, laser welding, MIG welding, riveting, or self-pierce riveting.

6. The RESS of claim 1, wherein the cold plate includes:
a fluid inlet;
a fluid outlet; and
one or more fluid pathways extending through the cold plate between the fluid inlet and the fluid outlet.

7. The RESS of claim 6, wherein the enclosure shell includes one or more sidewall recesses, at least one of the fluid inlet and the fluid outlet disposed at a sidewall recess of the one or more sidewall recesses.

8. The RESS of claim 1, wherein the plurality of battery cells are a plurality of prismatic battery cells.

9. A vehicle, comprising:
a vehicle body;
a powertrain disposed at the vehicle body to drive movement of the vehicle; and
a rechargeable energy storage system (RESS) operably connected to the powertrain, including:
a plurality of battery cells; and
a battery enclosure configured to contain the plurality of battery cells, the battery enclosure including:
an enclosure shell formed from a plurality of assembled metal components; and
a cold plate installed to at least one side of the enclosure shell, the cold plate in thermal communication with the plurality of battery cells to cool the plurality of battery cells disposed in the enclosure shell.

10. The vehicle of claim 9, wherein the enclosure shell includes:
a shell base;
a shell cap spaced apart from the shell base; and
a plurality of shell sidewalls extending between the shell base and the shell cap;
wherein the cold plate is disposed at the shell base.

11. The vehicle of claim 10, wherein the shell base includes one or more base openings to improve thermal contact between the cold plate and the plurality of battery cells.

12. The vehicle of claim 10, further comprising one or more dividers extending between two shell sidewalls of the enclosure shell.

13. The vehicle of claim 10, wherein the enclosure shell is formed via one or more of spot welding, laser welding, MIG welding, riveting, or self-pierce riveting.

14. The vehicle of claim 9, wherein the cold plate includes:
a fluid inlet;
a fluid outlet; and
one or more fluid pathways extending through the cold plate between the fluid inlet and the fluid outlet.

15. The vehicle of claim 14, wherein the enclosure shell includes one or more sidewall recesses, at least one of the fluid inlet and the fluid outlet disposed at a sidewall recess of the one or more sidewall recesses.

16. The vehicle of claim 9, wherein the plurality of battery cells are a plurality of prismatic battery cells.

17. A method of assembly of a rechargeable energy storage system (RESS), comprising:
forming a plurality of components of an enclosure shell;
arranging and assembling the enclosure shell from the plurality of components;
securing a cold plate to the enclosure shell; and
installing a plurality of battery cells into the enclosure shell after securing of the cold plate to the enclosure shell, the cold plate positioned in thermal contact with the plurality of battery cells.

18. The method of claim 17, wherein the plurality of components are formed by one of stamping or press-braking.

19. The method of claim 17, wherein the enclosure shell is assembled into a rectangular cuboid.

20. The method of claim 17, wherein the enclosure shell is assembled via one or more of spot welding, laser welding, MIG welding, riveting, or self-pierce riveting.
